(19) United States
(12) Patent Application Publication
(10) Pub. No.: US 2016/0375442 A1
(43) Pub. Date: Dec. 29, 2016

(54) MACHINE INTERFACE, DRIVE AND VERTICAL GRINDING MILL

(71) Applicant: SIEMENS AKTIENGESELLSCHAFT, München (DE)

(72) Inventors: ALI KEMAL KÜCÜKYAVUZ, Herne (DE); FRANZ SCHMEINK, Bocholt (DE)

(73) Assignee: SIEMENS AKTIENGESELLSCHAFT, München (DE)

(21) Appl. No.: 14/902,465

(22) PCT Filed: Jun. 20, 2014
(86) PCT No.: PCT/EP2014/063046

§ 371 Date: Dec. 31, 2015

(30) Foreign Application Priority Data
Jul. 3, 2013 (DE) 10 2013 213 005.8

(51) Int. Cl. B02C 15/00; B02C 23/24

(52) U.S. Cl. CPC B02C 15/006; B02C 15/007; B02C 23/24

(57) ABSTRACT

The invention concerns a machine interface (1) between a grinding pan (2) of a vertical grinding mill (3) and a drive (4) of the grinding pan (2). The machine interface (1) is designed such that the grinding pan (2) and the drive (4) are thermally decoupled.

The invention concerns a machine interface between a grinding pan of a vertical grinding mill and a drive of the grinding pan, a drive and a vertical grinding mill.

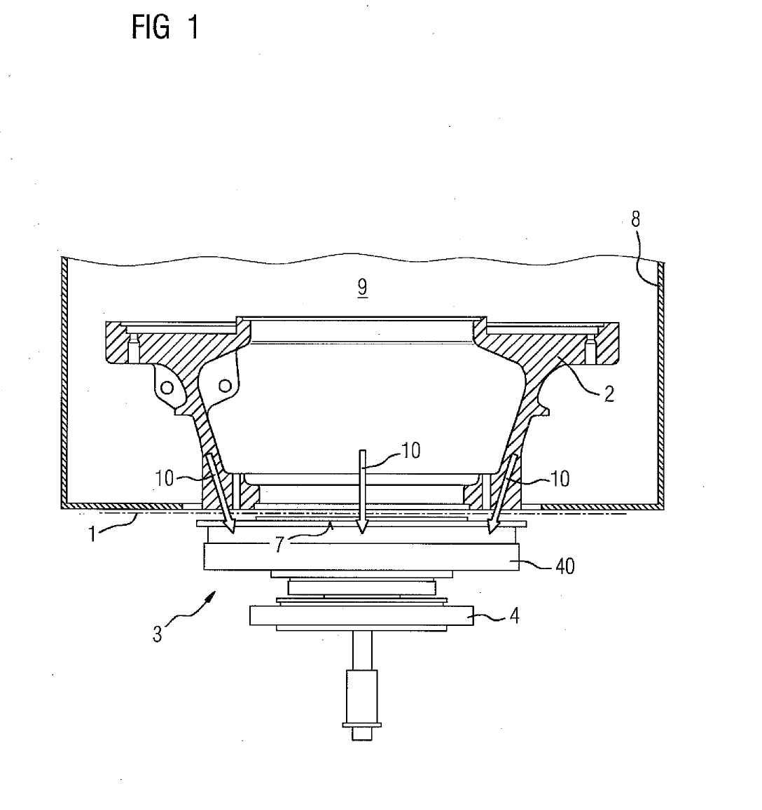

DE 2703535 A1 (Loesche), published Aug. 3, 1978, shows in FIG. 1 a roller mill having a grinding pan 7 rotating around the vertical axis and grinding rollers 4 running thereon. The grinding pan is driven by way of a transmission 9. Such mills, which are employed in a variety of applications, including cement manufacture, are also referred to as vertical grinding mills.

DE 10013097 C2 (Hitachi), published Sep. 27, 2001, describes a coal grinding mill having a number of pulverizing rollers and a pulverizing ring on which rolling surfaces for the pulverizing rollers are embodied. In this arrangement, coal guided between the pulverizing rollers and the pulverizing rings is pulverized. The mill additionally comprises a reduction gear which transmits the power for rotating the pulverizing rings from a motor to the pulverizing rings. Also provided in this configuration are a cooling fan, disposed in an input shaft of the reduction gear connected to the motor, and a radiator for cooling lubricating oil that lubricates the reduction gear. The radiator is arranged therein on the downstream side of the cooling fan.

In cement manufacture, a hot-gas generator is utilized during the grinding process for directly drying the mill feed in a vertical grinding mill. As a result a temperature of 80° C. to 130° C. is reached in the grinding chamber. Heat flows out from the grinding chamber to the drive via the interface between the grinding pan and its associated drive. Owing to this continuous flow of heat from the grinding chamber, the oil coolers used for cooling the drive, i.e. for cooling the gear teeth and the bearings, must be dimensioned for providing a greater capacity than would be necessary in the absence of a heated grinding chamber.

It is the object of the present invention to provide an improved machine interface between a grinding pan of a vertical grinding mill and a drive of the grinding pan, as well as a drive and a vertical grinding mill.

The object is achieved by means of a machine interface as claimed in claim 1, a drive as claimed in claim 3, and a vertical grinding mill as claimed in claim 4. Preferred developments of the invention are described in the dependent claims.

The machine interface according to the invention is located between a grinding pan of a vertical grinding mill and a drive of the grinding pan. In this arrangement, the machine interface is embodied in such a way that the grinding pan and the drive are thermally decoupled. Compared with conventional machine interfaces in vertical grinding mills, a flow of heat directed from the grinding pan to the drive is substantially reduced as a result.

The invention is based on the knowledge that the heat flow rate dQ/dt at which thermal energy is transferred through the machine interface between the grinding pan rotating in the grinding chamber to the drive can be described by means of the formula

dQ/dt=(λ/d)·A·ΔT

where

dQ=heat quantity,

dt=time interval,

λ=thermal conductivity

d=thickness,

A=surface area, and

ΔT=temperature difference.

A reduction in said heat flow rate can therefore be achieved by a reduction in the thermal conductivity λ and/or the surface area A of the machine interface.

The present machine interface constitutes a particularly cost-effective and robust solution because it is very simple in terms of its mechanical design. With the present invention, the oil coolers of vertical grinding mills can be dimensioned smaller than in the prior art. A rough estimation has yielded a potential cost saving of approx. 25% in comparison with conventional mills. This also leads to lower operating and running costs for the plant operator, e.g. a saving in power costs on account of the smaller oil supply system.

According to a preferred development of the invention, a heat-insulating material with respect to metal is arranged between the grinding pan and the drive. In addition or alternatively thereto, a contact surface between the grinding pan and the drive can be embodied as small as possible for a predetermined load-bearing capacity.

A thermal insulating layer is therefore arranged between components of the vertical grinding mill that are arranged in the grinding chamber and components that are cooled by means of a lubricant. Preferred heat-insulating materials fulfill the requirements in terms of mechanical loading capacity (load-bearing capacity, shear strength, etc.) to be met by the machine interface and exhibit low thermal conductivity in comparison with metal. Preferred heat-insulating materials have a thermal conductivity λ<1 W/(m·K), further preferably λ<0.5 W/(m·K). Suitable materials are e.g. ceramic or plastic in the form of disks or a surface coating. The greater the thickness d of the insulation material, the greater is its insulating effect, and consequently the reduction in the heat flow.

The machine interface between the grinding pan and the drive must satisfy specific requirements in terms of loading capacity that are to be defined by the mill operator and that arise during the operation of the mill, e.g. requirements in terms of load-bearing capacity, shear strength, elasticity, breaking resistance, etc. The bearing surface is reduced as far as possible within the scope of said requirements. The heat flow through the machine interface is reduced in proportion to the reduction in size of the bearing surface.

A preferred development of the invention is a drive, in particular a gearing mechanism, having a flange that is suitable for connecting a grinding pan, the flange being embodied as a machine interface as described hereinabove.

A further preferred development of the invention is a vertical grinding mill having a machine interface as described hereinabove.

The invention is explained hereinbelow with reference to the attached schematic drawings, which are not true to scale and in which:

FIG. 1 shows a first sectional view through a vertical grinding mill;

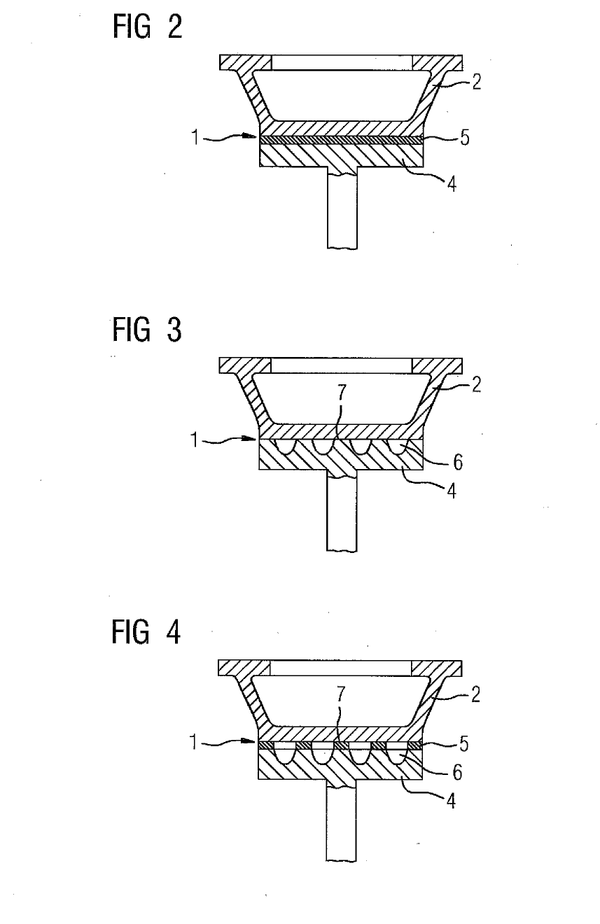

FIG. 2 shows a first embodiment of the machine interface;

FIG. 3 shows a further embodiment of the machine interface;

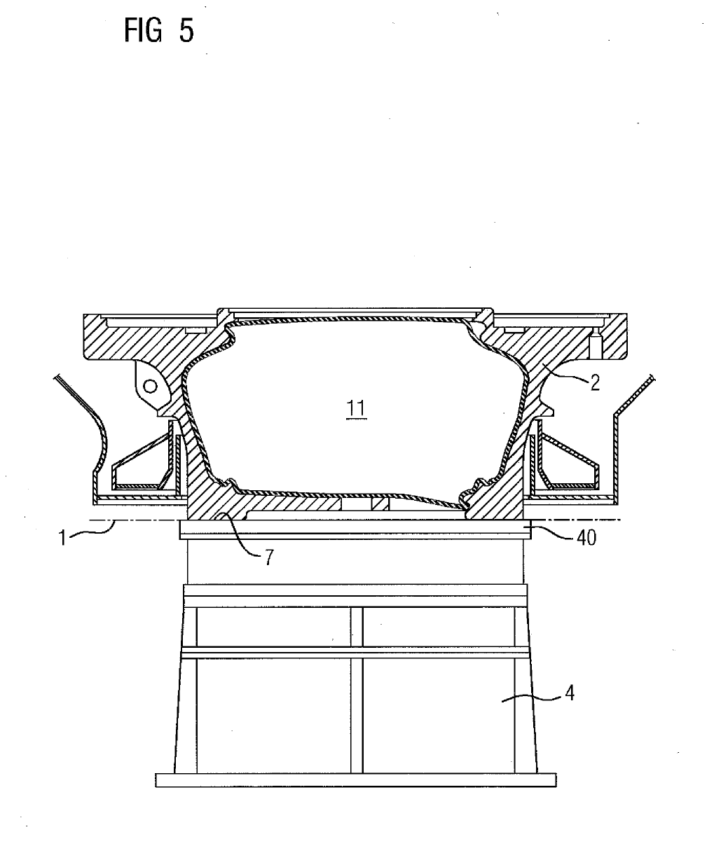

FIG. 4 shows a further embodiment of the machine interface; and

FIG. 5 shows a further sectional view through a vertical grinding mill.

FIG. 1 shows a section through a vertical grinding mill 3 having a rotatable grinding pan 2 and, associated with the grinding pan 2, a drive 4 which induces the rotation of the grinding pan 2. The vertical grinding mill 3 has a machine interface 1 between the grinding pan 2 and the drive 4. In this arrangement, the drive 4 has, on its vertical upper side, a drive flange 40 that is suitable for connecting the grinding pan 2. In this case the vertically upward directed side of the drive flange 40 embodies a contact surface 7 on which the grinding pan 2 bears on, the drive 4. The contact surface 7 of grinding pan 2 and drive flange 40 accordingly forms the said machine interface 1.

The grinding pan 2 is arranged in a grinding chamber 9 which is delimited by an enclosure 8. The heating of the grinding chamber 9 causes a heat flow 10 to be produced which transfers heat energy from the grinding pan 2 via the machine interface 1 to the drive 4. According to the invention, the machine interface 1 is now embodied in such a way that the heat flow 10 directed from the grinding pan 2 to the drive 4 is substantially impeded.

FIG. 2 shows a first embodiment of the invention. In this case a heat-insulating layer 5, e.g. in the form of a mat, a disk or a surface coating, is arranged at the machine interface 1 between the grinding pan 2 and the drive 4. The grinding pan 2 and the part of the drive 4 carrying the grinding pan 2 typically consist of a metal such as steel having a thermal conductivity λ in the range of approx. 15 to 60 W/(m·K). The heat-insulating layer 5, on the other hand, consists of a material which not only fulfills the requirements to be met in terms of mechanical loading capacity (load-bearing capacity, shear strength, etc.), but also possesses a relatively low thermal conductivity. A suitable material is e.g. Durobest, produced by the manufacturer AGK Hochleistungswerkstoffe GmbH, Dortmund (DE). The Durobest 110-280 high-performance material series comprises hard papers and fabric-based laminates having a thermal conductivity λ in the range of 0.18 to 0.3 W/(m·K).

FIG. 3 shows a further embodiment of the invention. In this case the contact surface 7 is not formed continuously over the entire surface area at the machine interface 1 between the grinding pan 2 and the drive 4, but is reduced in surface area by cutouts 6 machined on the upward-directed side of the drive flange 40. It is advantageous to reduce the contact surface of grinding pan 2 and drive 4 to the greatest extent possible while continuing to comply with the static requirements. As a consequence of the reduction in surface area, a heat flow rate is produced that is reduced, in the optimum case minimized, compared to a continuous, full-coverage contact surface.

FIG. 4 shows a further embodiment of the invention in which the embodiments according to FIG. 2 and FIG. 3 are combined with one another. The contact surface 7 reduced in surface area by a machining of cutouts 6 is covered by a heat-insulating layer 5.

FIG. 5 shows a further section through a vertical grinding mill. A grinding pan 2 is arranged on a horizontal drive flange 40 of the drive 4 by way of a drive element 4 comprising an electric motor and a planetary gear train. Embodied on the top side of the grinding pan 2 is a grinding bed on which grinding rollers (not shown) can run. Viewed along the axis of rotation of the grinding pan 2, the grinding pan 2 is embodied substantially in the shape of a ring and encloses an air space 11 in its interior. The underside of the grinding pan 2 bearing on the drive flange 40 of the drive 4 has a ring shape, with the result that the contact surface between the drive flange 40 and the grinding pan 2 bearing thereon likewise has a ring shape. According to the invention, the contact surface 7 is now embodied along the machine interface 1 in such a way that the grinding pan 2 and the drive 4 are thermally decoupled, e.g. by insertion of a thermally insulating layer between the underside of the grinding pan 2 and the top side of the drive flange 40 and/or by a reduction in surface area of the contact surface of grinding pan 2 and drive 4. In this way the heat flow 10 directed from the grinding pan 2 to the drive 4 is substantially impeded.

Although the invention has been illustrated and described in greater detail on the basis of the preferred exemplary embodiments, the invention is not limited by the disclosed examples.

What is claimed is:

1.-4. (canceled)

5. A machine interface between a grinding pan of a vertical grinding mill and a drive of the grinding pan, said machine interface being configured to thermally decouple the grinding pan and the drive.

6. The machine interface of claim 5, wherein the machine interface thermally decouples the grinding pan and the drive by a heat-insulating layer providing heat insulation with respect to metal and arranged between the grinding pan and the drive.

7. The machine interface of claim 6, wherein the heat-insulating layer is made of a material sufficient to maintain a predetermined loading capacity and having a thermal conductivity in a range of 0.18 to 0.3 W/(mK).

8. The machine interface of claim 5, wherein the machine interface thermally decouples the grinding pan and the drive by configuring a contact surface between the grinding pan and the drive of a size sufficient to maintain a predetermined loading capacity.

9. The machine interface of claim 8, wherein the contact surface is structured to include cutouts to reduce the size of the contact surface.

10. A drive, comprising a flange configured for attachment of a grinding pan of a vertical grinding mill, said flange being configured to form a machine interface to thermally decouple the grinding pan and the drive.

11. The drive of claim 10, constructed in the form of a gearing mechanism.

12. The drive of claim 10, further comprising a heat-insulating layer providing heat insulation with respect to metal and arranged between the grinding pan and the drive to form the machine interface to thermally decouple the grinding pan and the drive.

13. The drive of claim 12, wherein the heat-insulating layer is made of a material sufficient to maintain a predetermined loading capacity and having a thermal conductivity in a range of 0.18 to 0.3 W/(mK).

14. The drive of claim 10, wherein the machine interface thermally decouples the grinding pan and the drive by configuring a contact surface between the grinding pan and the drive of a size sufficient to maintain a predetermined loading capacity.

15. The drive of claim 14, wherein the contact surface is structured to include cutouts to reduce the size of the contact surface.

16. A vertical grinding mill, comprising:
a grinding pan;
a drive operably connected to the grinding pan; and
a machine interface configured to thermally decouple the grinding pan and the drive.

17. The vertical grinding mill of claim 16, further comprising a heat-insulating layer providing heat insulation with respect to metal and arranged between the grinding pan and the drive to form the machine interface to thermally decouple the grinding pan and the drive.

18. The vertical grinding mill of claim 17, wherein the heat-insulating layer is made of a material sufficient to maintain a predetermined loading capacity and having a thermal conductivity in a range of 0.18 to 0.3 W/(mK).

19. The vertical grinding mill of claim 16, wherein the machine interface thermally decouples the grinding pan and the drive by configuring a contact surface between the grinding pan and the drive of a size sufficient to maintain a predetermined loading capacity.

20. The vertical grinding mill of claim 19, wherein the contact surface is structured to include cutouts to reduce the size of the contact surface.

21. The vertical grinding mill of claim 16, wherein the drive includes a flange configured for attachment of the grinding pan, said flange being configured to form the machine interface to thermally decouple the grinding pan and the drive.
